(19) United States
(12) Patent Application Publication
(10) Pub. No.: US 2010/0316792 A1
(43) Pub. Date: Dec. 16, 2010

(54) METHOD OF FABRICATING ELECTRON EMISSION SOURCE AND METHOD OF FABRICATING ELECTRONIC DEVICE BY USING THE METHOD

(75) Inventors: Cheol Jin Lee, Seoul (KR); Seung Il Jung, Seoul (KR); Dong Hoon Shin, Seoul (KR)

Correspondence Address: BUCHANAN, INGERSOLL & ROONEY PC, POST OFFICE BOX 1404, ALEXANDRIA, VA, 22313-1404, US

(73) Assignee: KOREA UNIVERSITY INDUSTRY AND ACADEMY COOPERATION FOUNDATION, Seoul (KR)

(21) Appl. No.: 12/685,767

(22) Filed: Jan. 12, 2010

(30) Foreign Application Priority Data
Jun. 11, 2009 (KR) 10-2009-0051957

(51) Int. Cl. B05D 5/12

(52) U.S. Cl. 427/77

(57) ABSTRACT

A method of fabricating an electron emission source and a method of fabricating an electronic device by using the method. An electron emission material layer of the electron emission source is formed by filtration and transfer, and a mask including windows (openings) having predetermined patterns is used in a transfer process so that an electron emission layer having a desired shape may be freely obtained.

### CROSS-REFERENCE TO RELATED PATENT APPLICATIONS

This application claims the benefit of Korean Patent Application No. 10-2009-0051957, filed on Jun. 11, 2009, in the Korean Intellectual Property Office, the disclosure of which is incorporated herein in its entirety by reference.

### BACKGROUND OF THE INVENTION

1. Field of the Invention

The present invention relates to fabrication of an electron emission source and fabrication of electronic devices by using the method, and more particularly, a method of fabricating an electron emission source including a cathode formed of a needle-shaped electron emission material and a method of fabricating an electronic device by using the method.

2. Description of the Related Art

In electron emission sources including a fine structure, carbon nanotubes (CNTs) or nanoparticles are widely used as an electron emission material. CNTs are fine structures that are grown or composited in a tube or rod form and have various shapes. CNTs have excellent electrical, mechanical, chemical, and thermal characteristics, and thus have been used in various fields. CNTs have a low work function and a high aspect ratio. In addition, CNTs include a top end or an emission end having a small curvature radius, and thus have a very large field enhancement factor. Thus, CNTs may easily emit electrons from an electric field with a low electric potential.

Conventional methods of fabricating an electric field emission device by using CNTs include a screen printing method using a CNT paste and a chemical vapor deposition (CVD) method of directly vertically growing CNTs only in a patterned area of a substrate.

In the method of fabricating an electric field emission device by using the screen printing method, a photosensitive CNT paste is applied to the entire surface of a substrate, and an electron emission material layer is optionally patterned by performing a photolithography process, or a CNT paste is applied to only a limited area of the substrate. However, the screen printing method is complicated, it is difficult to adjust the density of an electron emission unit, and reproducibility is low. In particular, due to contamination of an electric field electron emission source due to an organic binder material, the performance of the electric field electron emission source and the stability of the electric field emission device are remarkably reduced.

In the method of fabricating an electric field emission device by vertically growing CNTs by CVD, an adhesion force between a substrate and the CNTs is relatively low and is also easily removable.

### SUMMARY OF THE INVENTION

The present invention provides a simple method of fabricating an electron emission source having high reliability and a high current density, and a method of fabricating an electronic device by using the method.

According to an aspect of the present invention, there is provided a method of fabricating an electron emission source, the method including: forming an electron emission material layer on a plate-shaped template; preparing a target substrate on which cathodes are disposed; preparing a mask including a plurality of windows for forming a plurality of electron emission layers that correspond to the cathodes; and after the target substrate on which the cathodes are disposed, is covered by the mask, pressurizing the electron emission material layer formed on the template and forming the electron emission layers corresponding to shapes of the windows on the cathodes.

According to another aspect of the present invention, there is provided a method of fabricating an electron emission array, the method including: forming a plurality of stripe-shaped cathodes on a target substrate, such that the cathodes are parallel to each other; preparing a mask comprising a plurality of windows for forming a plurality of electron emission layers that correspond to the cathodes and are arranged in lengthwise directions of the cathodes; forming an electron emission material layer on a plate-shaped template having a size corresponding to the target substrate; and after the target substrate on which the cathodes are disposed, is covered by the mask, pressurizing the electron emission material layer formed on the template and forming the electron emission layers corresponding to shapes of the windows on the cathodes.

The method may further include performing surface treatment to erect the electron emission layers transferred to the cathodes with respect to the cathodes.

A surface of the cathodes may have an adhesive property with respect to the electron emission material so that the electron emission layers are attached to the surface of the cathodes. The adhesive property may be applied to a body of the cathodes. The adhesive property may be applied to a conductive adhesive material applied to the surface of the cathodes. The adhesive property may be applied by a conductive double-sided tape in which the conductive adhesive material is applied to one or both sides of a conductive thin plate. Also, the adhesive property may be obtained by forming the cathodes of a paste and halfway curing the paste. In this case, processes of forming and drying cathodes using a conductive paste may be performed, and after the electron emission layers are formed, curing may be performed.

The template may be in the form of a filter paper, and the electron emission layers may be formed by applying and drying a suspension in which a needle-shaped electron emission material is dispersed.

The electron emission material may be the needle-shaped electron emission material, i.e., a tube- or rod-shaped electron emission material having a predetermined length, for example, a carbon nano tube (CNT) powder. The suspension may include the needle-shaped electron emission material, water, and a surfactant. An appropriate amount of the suspension may be applied to a porous filtration template, and then is dried so that only the electron emission material may remain on the template. CNT may be very uniformly dispersed in the suspension. Thus, a CNT electron emission material layer to be formed on the template may also include CNT having uniform dispersion. A CNT layer may be transferred on the cathodes in which an adhesive layer is formed. Thus, the CNT layer may be stably formed on the cathodes. CNT may be erected with respect to the cathodes by performing surface treatment on the CNT layer so that the number of CNTs that are conducive to electron emission may be remarkably increased. According to the present invention, the CNT layer may be formed on the cathodes at a lower temperature or room temperature and thus, problems caused by conventional high-temperature treatment may not occur. Thus, the electron emission source according to the present invention may have a very stable structure and perform electron emission having uniform dispersion.

According to the present invention, a large-scaled electron emission source and an electronic device using the same, for example, a large display may be fabricated.

### BRIEF DESCRIPTION OF THE DRAWINGS

The above and other features and advantages of the present invention will become more apparent by describing in detail exemplary embodiments thereof with reference to the attached drawings in which:

FIGS. 1, 2, 3A, and 3B are schematic perspective views of electron emission sources according to embodiments of the present invention;

FIGS. 4A, 4B, and 4C are partial cross-sectional views of cathodes of the electron emission sources of FIGS. 1, 2, 3A, and 3B;

FIGS. 5A through 5E are cross-sectional views illustrating a method of fabricating the electron emission source having the single island-shaped electron emission layer of FIG. 1, according to an embodiment of the present invention; and

FIGS. 6A through 6I are cross-sectional views illustrating a method of fabricating an electronic device, e.g., a display, according to an embodiment of the present invention.

### DETAILED DESCRIPTION OF THE INVENTION

The present invention will now be described more fully with reference to the accompanying drawings, in which exemplary embodiments of the invention are shown.

The present invention uses a needle-shaped electron emission material. The needle-shaped electron emission material may be in the form of hollow nanotubes, non-hollow nanorods, nanowires, fibers, or nanofibers. The needle-shaped electron emission material may be carbon, but may also be other metallic materials. In the following embodiments of the present invention, carbon nanotubes (CNT) will be described as a representative example of the needle-shaped electron emission material. However, all needle-shaped electron emission materials may be used. Thus, the present invention is not limited to a particular example of the needle-shaped electron emission material.

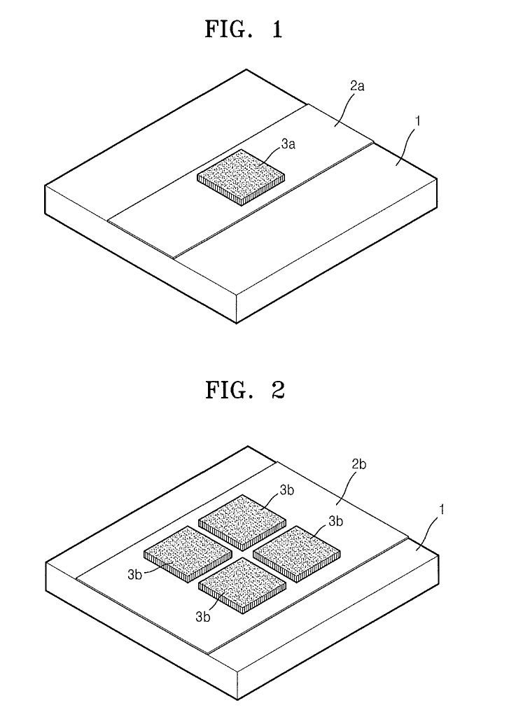

FIGS. 1, 2, 3A, and 3B are schematic perspective views of electron emission sources according to embodiments of the present invention. Referring to FIG. 1, an electron emission source according to an embodiment of the present invention includes a cathode 2a disposed on a substrate 1, and an island-shaped electron emission layer 3a disposed on the cathode 2a.

Referring to FIG. 2, an electron emission source according to another embodiment of the present invention includes a cathode 2b disposed on a substrate 1, and a plurality of island-shaped electron emission layers 3b disposed in an array form on the cathode 2b. According to the present invention, various shapes of electron emission layers 3b may be obtained.

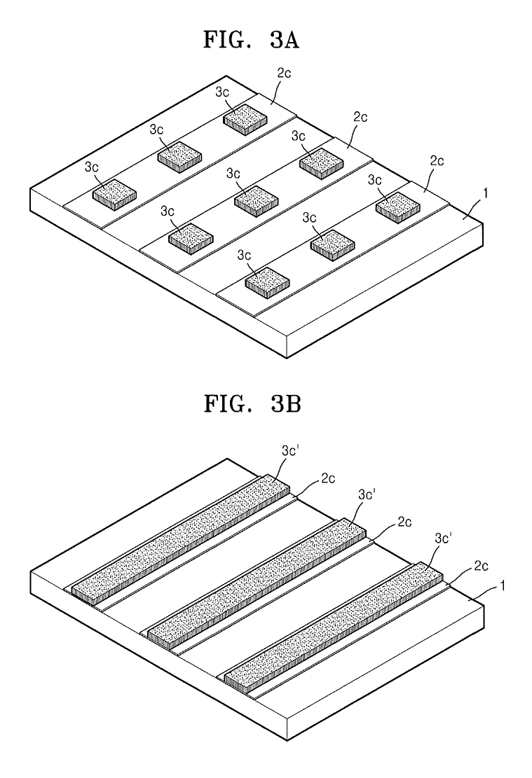

Referring to FIG. 3A, an electron emission source according to another embodiment of the present invention has an electron emission source structure in a matrix of a display device, i.e., a cathode plate. A plurality of parallel cathodes 2c are disposed on a substrate 1, and a plurality of island-shaped electron emission layers 3c corresponding to unit pixels of the display device are disposed on the cathodes 2c at predetermined intervals.

Referring to FIG. 3B, an electron emission source according to another embodiment of the present invention is a modified example of the electron emission source of FIG. 3A. The electron emission source of FIG. 3B includes a plurality of stripe-shaped or strip-shaped electron emission layers 3c′ respectively extending along a plurality of cathodes 2c.

In the electron emission sources of FIGS. 1, 2, 3A, and 3B, the electron emission layers 3a, 3b, 3c, and 3c′ include the above-described needle-shaped electron emission materials and are physically and fixedly attached to the cathodes 2a, 3b, and 2c disposed under the electron emission layers 3a, 3b, 3c, and 3c′.

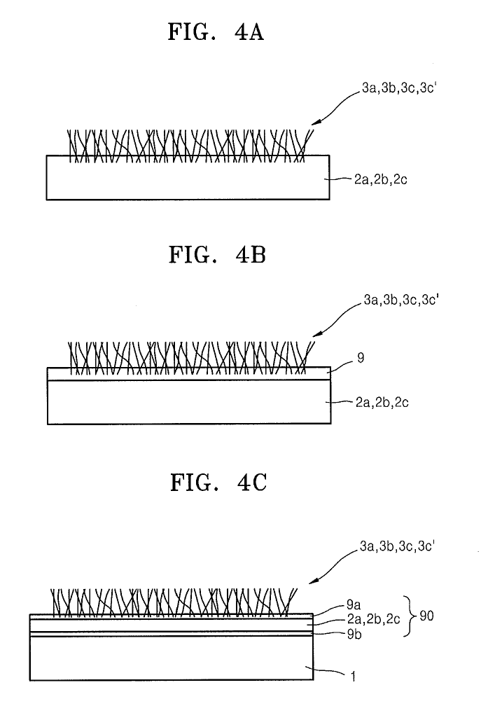

FIGS. 4A, 4B, and 4C are partial cross-sectional views of the cathodes 2a, 2b, and 2c of the electron emission sources of FIGS. 1, 2, 3A, and 3B. Referring to FIG. 4A, the electron emission layers 3a, 3b, 3c, and 3c′ may be fixedly attached to the surfaces of the cathodes 2a, 2b, and 2c. Referring to FIG. 4B, the electron emission layers 3a, 3b, 3c, and 3c′ may be fixedly attached to the cathodes 2a, 2b, and 2c by an additional conductive adhesive material layer 9. The conductive adhesive material layer 9 may be a conductive polymer, conductive double-sided tape or a silver (Ag) paste. The electron emission layers 3a, 3b, 3c, and 3c′ are fixedly attached due to an adhesion property of the surfaces of the cathodes 2a, 2b, and 2c. The adhesion property is conducive to move an electron emission material securely to the cathodes 2a, 2b, and 2c from a template during a transfer process of an electron emission material layer in a method of fabricating an electron emission source that will be described later. Referring to FIG. 4C, an electron emission source according to another embodiment of the present invention is illustrated. The electron emission source illustrated in FIG. 4C has an additional conductive material layer. That is, referring to FIG. 4C, a conductive double-sided tape 90 including an upper adhesive material layer 9a and a lower adhesive material layer 9b are respectively formed on both sides of the cathodes 2a, 2b, and 2c. The upper adhesive material layer 9a is used to attach a needle-shaped electron emission material for forming the electron emission layers 3a, 3b, 3c, and 3c′ as a conductor. The lower adhesive material layer 9b is used to attach the cathodes 2a, 2b, and 2c to a substrate 1. In the above-described structures illustrated in FIGS. 4A, 4B, and 4C, the cathodes 2a, 2b, and 2c may be formed of Ag, copper (Cu), nickel (Ni), an Ag layer having a small or large thickness or an Ag paste. In the above description, the cathodes 2a, 2b, and 2c and the conductive adhesive material layer 9 disposed on the cathodes 2a, 2b, and 2c are described as different elements. However, for convenience of explanation, while the conductive adhesive material layer 9 is a different element from the cathodes 2a, 2b, and 2c, it has conductivity and thus may be interpreted as an element of the cathodes 2a, 2b, and 2c. The technical scope of embodiments is not limited by the structure of the cathodes 2a, 2b, and 2c, for example, by a particular structure such as a single layer or a multi-layer structure including different or the same types of material layers.

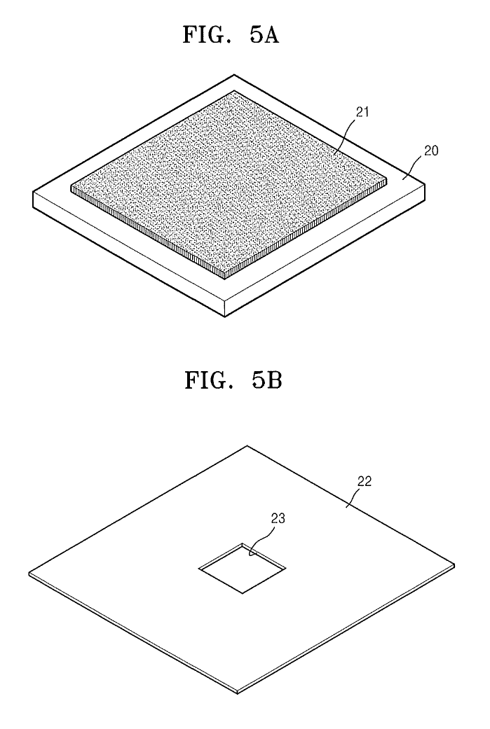

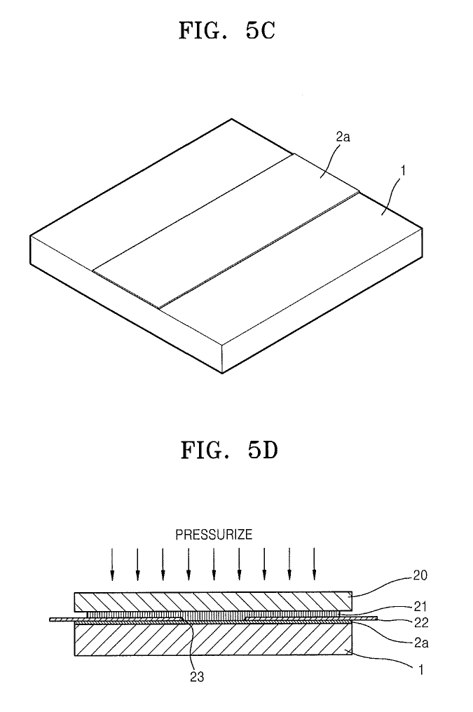

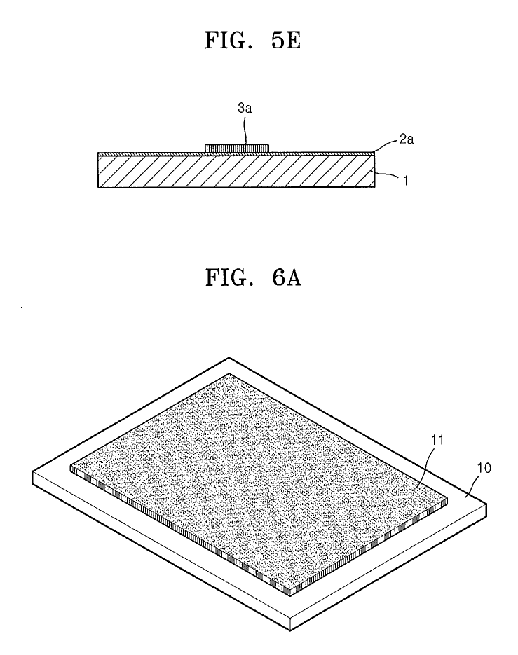

Hereinafter, a method of fabricating the electron emission source having the single island-shaped electron emission layer 3a of FIG. 1, according to an embodiment of the present invention, will be described. FIGS. 5A through 5E are cross-sectional views illustrating a method of fabricating the electron emission source having the single island-shaped electron emission layer 3a of FIG. 1, according to an embodiment of the present invention.

First, a CNT colloid suspension (hereinafter, suspension), and a filter paper (filtration template) formed of Teflon, ceramic, anodic aluminum oxide (AAO) or polycarbonate are prepared. The suspension is a liquid in a colloid state that is prepared by dispersing a needle-shaped electron emission material in a powder form, i.e., CNTs in a solvent and a surfactant. For more uniform dispersion of the needle-shaped electron emission material, the suspension may be treated by ultrasonic waves. The filtration template filtrates the suspension and allows a CNT to remain on the surface of the suspension. The filtration template is used to dry the CNT suspension, to retain only the CNTs in a predetermined pattern and to transfer the remaining CNTs to a plate-shaped cathode. Examples of the CNTs include single-walled carbon nanotubes (SWCNT), double-walled carbon nanotubes (DWCNT), and multi-walled carbon nanotubes (MWCNT). Examples of the MWCNT include thick MWCNT and thin MWCNT. Meanwhile, the solvent may be ethanol, dimethyl formamide, tetrahydrofuran, dimethyl acetamide, 1,2 dichloroethane, or 1,2 dichlorobenzene.

Examples of the surfactant include sodium dodecylbenzene sulfonate (NaDDBS C1₂H₂₅C₆H₄SO₃Na), sodium butylbenzene sulfonate (NaBBS C₄H₉C₆H₄SO₃Na), sodium benzoate (C₆H₅CO₂Na), sodium dodecyl sulfate (SDS; CH₃(CH₂)₁₁OSO₃Na), Triton X-100 (TX100; C₈H₁₇C₆H₄(OCH₂CH₂)ₙ—OH; n 10), dodecyltrimethylammonium bromide (DTAB; CH₃(CH₂)₁₁N(CH₃)₃Br), and Arabic Gum.

Referring to FIG. 5A, an appropriate amount of the suspension is applied to a porous filtration template 20 in the form of a filter paper, and then is dried to form an electron emission material layer 21. An area in which the suspension is to be applied is appropriately adjusted so that the suspension sufficiently covers an area in which a window of a mask to be used in a subsequent transfer process is to be formed.

Referring to FIG. 5B, a mask 22 having a window 23 as described above is prepared. The mask 22 may be a metal or plastic thin plate. The window 23 may be formed as a rectangle corresponding to each of the electron emission layers 3a, 3b, and 3c of FIGS. 1, 2, and 3A, or as a slit corresponding to each of the long stripe-shaped electron emission layers 3c′ of FIG. 3B or to have various shapes such as a circle, a triangle or a pentagon, an oval or a star. That is, the present invention is not limited to the embodiment illustrated in FIG. 5B.

Referring to FIG. 5C, a target substrate 1 (hereinafter, referred to as the substrate 1) is prepared, and then a cathode 2a is formed on the substrate 1. The cathode 2a may be formed of a conductive fabric or may be a metal plate. An upper surface of the cathode 2a has an adhesive property. Also, the body of the cathode 2a may have an adhesive property, and according to an embodiment of the present invention, an additional conductive adhesive layer may be formed.

The upper surface of the cathode 2a may have an appropriate adhesive property by applying a conductive paste to the cathode 2a and patterning the cathode 2a by photolithography and then soft-annealing the cathode 2a by using an etchant, or screen printing the conductive paste in the form of a cathode and then soft-annealing the cathode 2a. Meanwhile, the upper surface of the cathode 2a may obtain an appropriate adhesive property by forming the cathode 2a of a metal or other material, and then applying a metal or other material to the upper surface of the cathode 2a, or applying a conductive tape including a conductive adhesive material to one or both sides of a conductive ribbon.

The conductive adhesive material may be formed of conductive particles, for example, a material in which modified nickel and polymer resin are mixed. Specifically, the cathode 2a may be an aluminum (Al) foil having a thickness of 0.01 to 0.04 mm, a conductive sheet having a thickness of 0.01 to 0.04 mm and formed of copper (Cu)- or nickel (Ni)-group or a conductive fabric having a thickness of 0.01 to 0.20 mm. In detail, the cathode 2a may be a conductive sheet including at least one of the group consisting of Al, Cu, and Ni and a conductive fabric. Examples of the conductive adhesive material applied to one or both sides of the cathode 2a include a mixture of a conductive powder such as a Ni or carbon pigment and an adhesive resin such as acrylic ester polyol copolymer.

Referring to FIG. 5D, the mask 22 is applied to the cathode 2a disposed on the substrate 1, and then the template 20 is inverted and applied to the mask 22. Then pressure is applied to the template 20 toward the substrate 1 and then the template 20 is separated from the mask 22. In this case, the electron emission material layer 21 formed on the bottom surface of the template 20 partially contacts the cathode 2a having an adhesive property via the window 23, is adhered to the cathode 2a, and the mask 22 and the template 20 are separated from each other so that an electron emission material may be optionally transferred to the upper surface of the cathode 2a. Thus, referring to FIG. 5E, an electron emission layer 3a may be formed in a desired location on the cathode 2a.

After the above-described procedure has been performed, as described above, a paste that is not completely cured may be soft-annealed at a higher temperature and may be completely cured.

The electron emission layer 3a having a predetermined pattern may be formed using the above-described method. The density of the needle-shaped electron emission material, such as CNTs, in the electron emission layer 3a may be adjusted using a suspension including a solvent and a surfactant.

The needle-shaped electron emission material, such as CNTs, for forming the electron emission layer 3a formed using the above-described method may be erected with respect to the cathode 2a by performing general surface treatment, for example, taping or polymer molding. Alternatively, the surface of the electron emission layer 3a may be rolled by a roller having an adhesive property so that the needle-shaped electron emission material may be erected with respect to the cathode 2a.

A method of fabricating an electron emission source having a plurality of electron emission layers as illustrated in FIG. 3 may be easily performed by understanding the above-described processes. In this case, a plurality of windows 23 of the mask 22 may be formed to correspond to a desired arrangement of the plurality of electron emission layers.

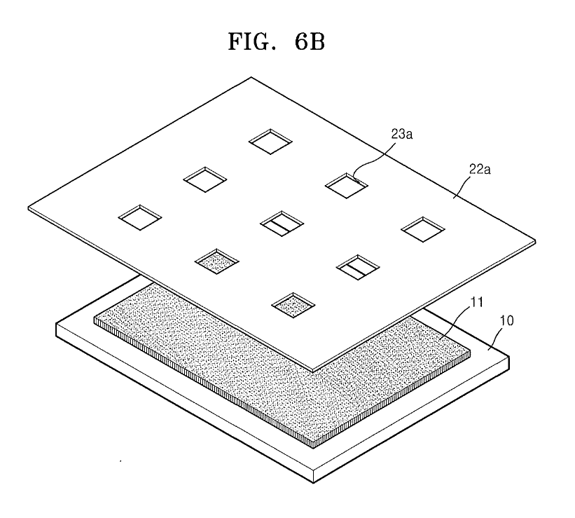

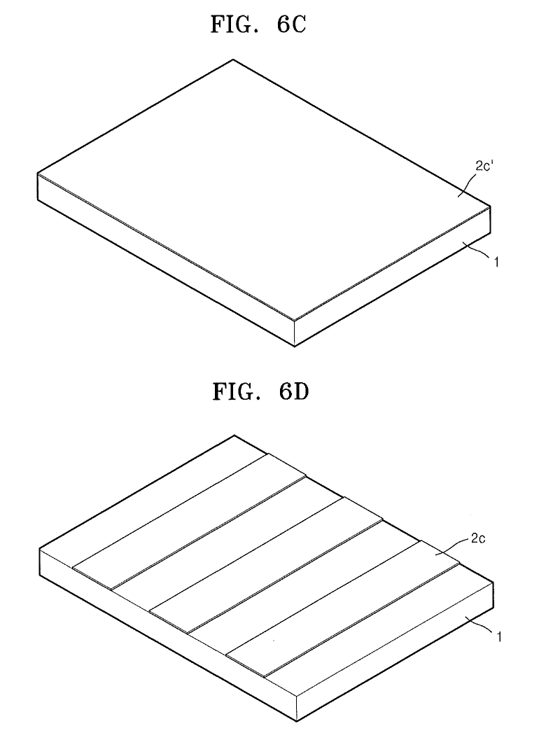

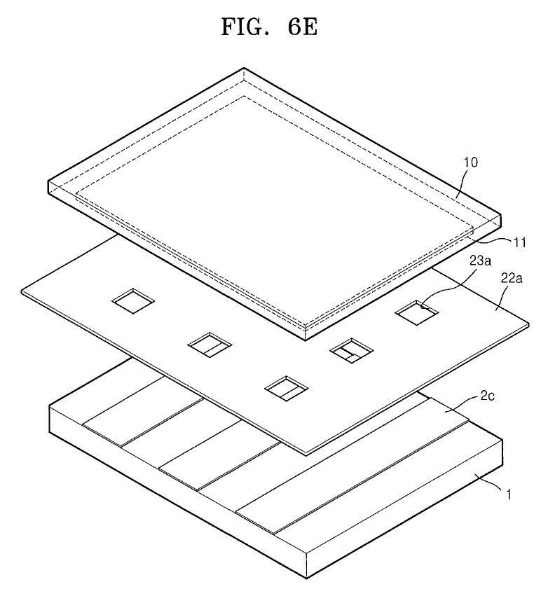

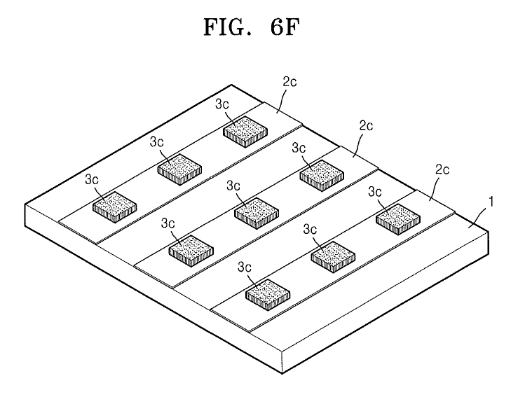

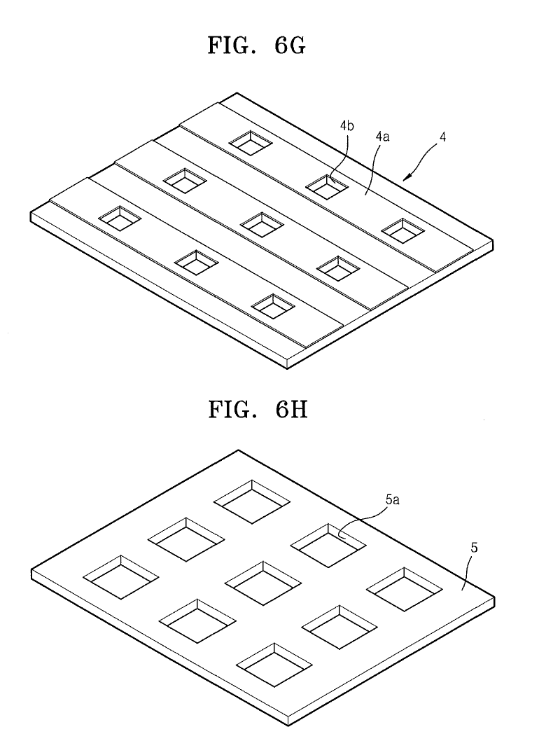

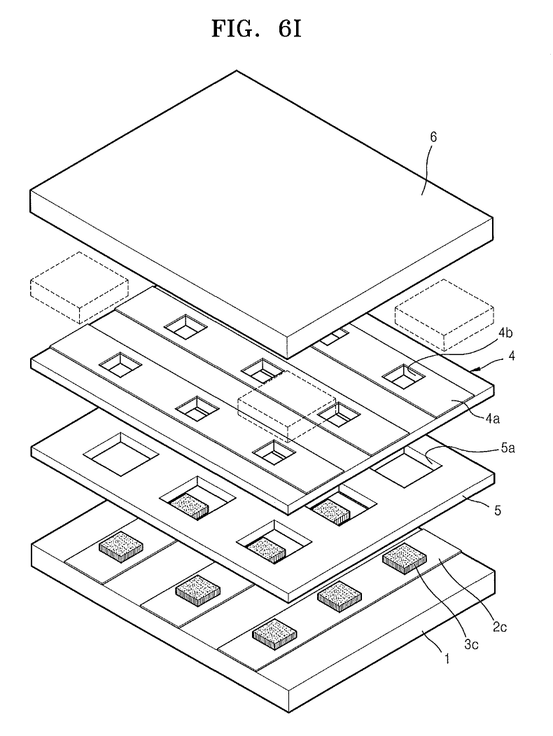

A method of fabricating an electronic device, i.e., a display having a matrix structure, unlike the electron emission source having the single island-shaped electron emission layer 3a of FIG. 1, according to an embodiment of the present invention, will now be described. The basic structure of the electronic device or material for forming the electronic device is as described above. FIGS. 6A through 6I are cross-sectional views illustrating a method of fabricating an electronic device, e.g., a display, according to an embodiment of the present invention.

Referring to FIG. 6A, the above-described needle-shaped electron emission material suspension is applied to a porous template 10 and then is dried to form an electron emission material layer 11.

Referring to FIG. 6B, a mask 22a formed of a thin plate having a plurality of windows 23a is prepared, wherein the thin plate has an area in which the mask 22a sufficiently covers the electron emission material layer 11. The windows 23a correspond to unit pixels of an electronic device, e.g., a field emission display and have to correspond to the arrangement of cathodes that will be described later. Here, when the windows 23a are slit-shaped, the stripe-shaped electron emission layers 3c′ of FIG. 3B may also be formed.

Referring to FIG. 6C, after a substrate 1 is prepared, a conductive layer 2c′ for forming cathodes is formed on an upper surface of the substrate 1.

Referring to FIG. 6D, the conductive layer 2c′ is patterned to form a plurality of stripe-shaped cathodes 2c.

Referring to FIG. 6E, after the mask 22a is applied on the cathodes 2c, the porous template 10 is inverted so that the electron emission material layer 11 faces the cathodes 2c, and is pressurized toward the substrate 1 so that the electron emission material layer 11 may be optically transferred to the cathodes 2c.

FIG. 6F illustrates an electron emission source (cathode plate) having a matrix structure that is obtained using the above-described method and is the same as that of the electron emission source of FIG. 3A. The cathode plate is to be used in the display.

FIG. 6G illustrates a gate plate 4 that is to be used in the display and fabricated through an additional process. The gate plate 4 of FIG. 6G includes gate electrodes 4a that extend in a direction perpendicular to the cathodes 2c, and gate holes 4b corresponding to the electron emission layers 3c.

FIG. 6H illustrates a spacer plate 5 that is fabricated through an additional process and is to be interposed between the gate plate 4 and the cathode plate.

The spacer plate 5 of FIG. 6H includes a plurality of through holes 5a corresponding to the gate holes 4b. In the present embodiment, a plate-shaped spacer plate 5 is used; however, the present embodiment is not limited thereto. That is, pillar- or bar-shaped spacers may also be used.

FIG. 6I is a perspective exploded view of a basic stack structure of the display. The spacer plate 5 and the gate plate 4 are disposed on the above-described cathode plate, and an anode plate 6 is disposed on the spacer plate 5 and the gate plate 4. Anodes (not shown) are disposed on inner surfaces of the anode plate 6, and phosphor layers (not shown) may be formed on the anodes. In FIG. 6I, blocks below the anode plate 6 and indicated by dotted lines denote spacers for maintaining a distance between the anode plate 6 and the gate plate 4. The spacers may have various shapes, and the present invention is not limited to the shapes illustrated in FIG. 6I.

The basic stack structure of the display of FIG. 6I may be applied to a display and a matrix switch array. In this case, phosphor layers do not have to be disposed on anodes.

As described above, according to the present invention, a CNT thin layer that is formed by filtration using a suspension may be transferred using a mask so that electron emission layers having predetermined patterns may be easily formed. In this case, cathode surfaces have an adhesive property so that the electron emission layers may be stably fixedly attached to the cathodes.

The embodiments of the present invention may be applied in the fabrication of lamps, display devices, backlight units for flat panel displays, electronic sources for X-ray devices, and electronic sources for high-output microwaves. Also, individual cells may be optically and independently driven so that an integrated vacuum device may be implemented.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A method of fabricating an electron emission source, the method comprising:
forming an electron emission material layer on a plate-shaped template;
preparing a target substrate on which cathodes are disposed;
preparing a mask comprising a plurality of windows for forming a plurality of electron emission layers that correspond to the cathodes; and
after the target substrate on which the cathodes are disposed, is covered by the mask, pressurizing the electron emission material layer formed on the template and forming the electron emission layers corresponding to shapes of the windows on the cathodes.

2. The method of claim 1, further comprising performing surface treatment to erect the electron emission layers transferred to the cathodes with respect to the cathodes.

3. The method of claim 1, wherein a surface of the cathodes has an adhesive property so that the electron emission layers are attached to the surface of the cathodes.

4. The method of claim 3, wherein the adhesive property is applied to a body of the cathodes.

5. The method of claim 3, wherein the adhesive property is applied to a conductive adhesive material applied to the surface of the cathodes.

6. The method of claim 5, wherein the cathodes and the conductive adhesive material comprise a conductive double-sided tape in which the conductive adhesive material is applied to one or both sides of a conductive thin plate.

7. The method of claim 4, wherein the cathodes have the adhesive property by applying a conductive paste to the cathodes.

8. The method of 1, wherein the electron emission material layer is formed using a suspension in which a needle-shaped electron emission material is dispersed.

9. The method of claim 8, wherein the suspension comprises a solvent and a surfactant.

10. The method of claim 1, wherein the needle-shaped electron emission material comprises at least one selected from the group consisting of a single-walled carbon nano tube (SWCNT), a double walled CNT (DWCNT), a multi-walled CNT (MWCNT), nanowires, nanorods, fibers, nanofibers, and nanoparticles.

11. A method of fabricating an electron emission array, the method comprising:
forming a plurality of stripe-shaped cathodes on a target substrate, such that the cathodes are parallel to each other;
preparing a mask comprising a plurality of windows for forming a plurality of electron emission layers that correspond to the cathodes and are arranged in lengthwise directions of the cathodes;
forming an electron emission material layer on a plate-shaped template having a size corresponding to the target substrate; and
after the target substrate on which the cathodes are disposed, is covered by the mask, pressurizing the electron emission material layer formed on the template and forming the electron emission layers corresponding to shapes of the windows on the cathodes.

12. The method of claim 11, wherein the plurality of stripe-shaped cathodes are disposed on the target substrate to be parallel to each other, and the electron emission layers are formed on the cathodes at regular intervals.

13. The method of claim 11, wherein the plurality of stripe-shaped cathodes are disposed on the target substrate to be parallel to each other, and the electron emission layers linearly extend along the cathodes.

14. The method of claim 11, further comprising performing surface treatment to erect the electron emission layers transferred to the cathodes with respect to the cathodes.

15. The method of claim 11, wherein a surface of the cathodes has an adhesive property so that the electron emission layers are attached to the surface of the cathodes.

16. The method of claim 15, wherein the adhesive property is applied to a body of the cathodes.

17. The method of claim 15, wherein the adhesive property is applied to a conductive adhesive material applied to the surface of the cathodes.

18. The method of claim 17, wherein the cathodes and the conductive adhesive material comprise a conductive double-sided tape in which the conductive adhesive material is applied to one or both sides of a conductive thin plate.

19. The method of claim 16, wherein the cathodes have the adhesive property by applying a conductive paste to the cathodes.

20. The method of 11, wherein the electron emission material layer is formed using a suspension in which a needle-shaped electron emission material is dispersed.

21. The method of claim 20, wherein the suspension comprises a solvent and a surfactant.

22. The method of claim 11, wherein the needle-shaped electron emission material comprises at least one selected from the group consisting of a single-walled carbon nano tube (SWCNT), a double walled CNT (DWCNT), a multi-walled CNT (MWCNT), nanowires, nanorods, fibers, nanofibers, and nanoparticles.

23. A method of fabricating an electronic device, the method comprising operations of the method of one of claim 1.

24. A method of fabricating a display, the method comprising operations of the method of claim 11.

25. The method of claim 24, further comprising forming anodes on inner surfaces of an anode plate corresponding to a substrate and forming phosphor layers on the anodes.

26. A method of fabricating an electronic device, the method comprising operations of the method of claim 11.
